(19) United States
(12) Patent Application Publication
(10) Pub. No.: US 2007/0291787 A1
(43) Pub. Date: Dec. 20, 2007

(54) Methods, devices, and computer program products for ordering communication services

(76) Inventor: Mounire El Houmaidi, Atlanta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/453,526

(22) Filed: Jun. 15, 2006

(51) Int. Cl. H04J 3/22

(52) U.S. Cl. 370/465; 370/401

(57) ABSTRACT

Methods, computer program products, and devices for ordering a communication service. The customer premises is monitored to detect an initiation of communication by an endpoint device at the customer premises and, upon detection thereof, it is determined whether or not a communication service is provisioned for the customer premises. If a communication service is not provisioned for the customer premises, then a communications link is initiated between the endpoint device and an ordering system of a service provider over the network.

### BACKGROUND

Exemplary embodiments relate generally to communication services and, more particularly, to methods, systems, and computer program products for ordering communication services.

When an individual first moves into a home, condominium, apartment, office, or other space, existing connections for communication services such as high-speed Internet access, cable television, and local telephone service are usually inoperative. In order to initiate service, the new occupant may contact a service provider using a wireless phone or a phone at work. However, the occupant is faced with a multitude of confusing choices as to which service provider should be contacted. For example, the occupant may know the names of three or four different cable companies that operate in a given metropolitan area, but may be unaware as to which of these companies could provide service to his or her new space. Another difficulty may arise in situations where a communication service that provided high-speed Internet access to the occupant at his or her former space only offers dial-up service at the new space. As a practical matter, selecting an appropriate service provider oftentimes becomes a tedious and time-consuming ordeal. The procedure involves a certain amount of trial and error, causing many customers to become frustrated and annoyed.

From the standpoint of the communication service provider, existing methods of accepting and processing new customer orders are inefficient, resulting in customer attrition over time. When an existing customer moves away from a given address and disconnects service, the new occupant may arrange for service from a different provider. Moreover, due to the ever-increasing popularity of voice over Internet protocol (VoIP) communication, many customers are no longer interested in conventional local wired telephone service. Such customers may elect to obtain broadband Internet service from a cable company, thereby decreasing the market share of traditional telephone carriers. In view of the aforementioned shortcomings, it would be desirable to provide customers with a fast, efficient, and convenient method of ordering communication services.

### BRIEF SUMMARY

Exemplary embodiments relate to methods of ordering a communication service. These methods comprise monitoring a customer premises to detect an initiation of communication by an endpoint device at the customer premises and, upon detection thereof, determining whether or not a communication service has been provisioned for the customer premises. If a communication service has not been provisioned for the customer premises, then a communications link is initiated between the endpoint device and an ordering system of a service provider.

Additional exemplary embodiments include computer program products comprising a storage medium readable by a processing circuit and storing instructions for execution by the processing circuit for facilitating methods of ordering a communication service. The methods comprise monitoring a customer premises to detect an initiation of communication by an endpoint device at the customer premises and, upon detection thereof, determining whether or not a communication service has been provisioned for the customer premises. If a communication service has not been provisioned for the customer premises, then a communications link is initiated between the endpoint device and an ordering system of a service provider.

Further exemplary embodiments include devices for enabling a communication service to be ordered. The devices comprise a communications link initiation mechanism for initiating a communications link between an endpoint device and an ordering system of a service provider, a monitoring mechanism for monitoring a customer premises to detect an initiation of communication by an endpoint device, and an interrogation mechanism for interrogating a customer database to determine whether or not a communication service has been provisioned for the customer premises. The communications link initiation mechanism initiates a communications link between the endpoint device and the ordering system in response to the initiation of communication by the endpoint device if a communication service has not been provisioned for the customer premises.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram of an exemplary system that may be utilized for ordering communication services.

FIG. 2 is a flow diagram of a first exemplary process for ordering communication services; and

FIGS. 3A and 3B together comprise a flow diagram of a second exemplary process for ordering communication services.

The detailed description explains the exemplary embodiments, together with advantages and features, by way of example with reference to the drawings.

### DETAILED DESCRIPTION OF EXEMPLARY EMBODIMENTS

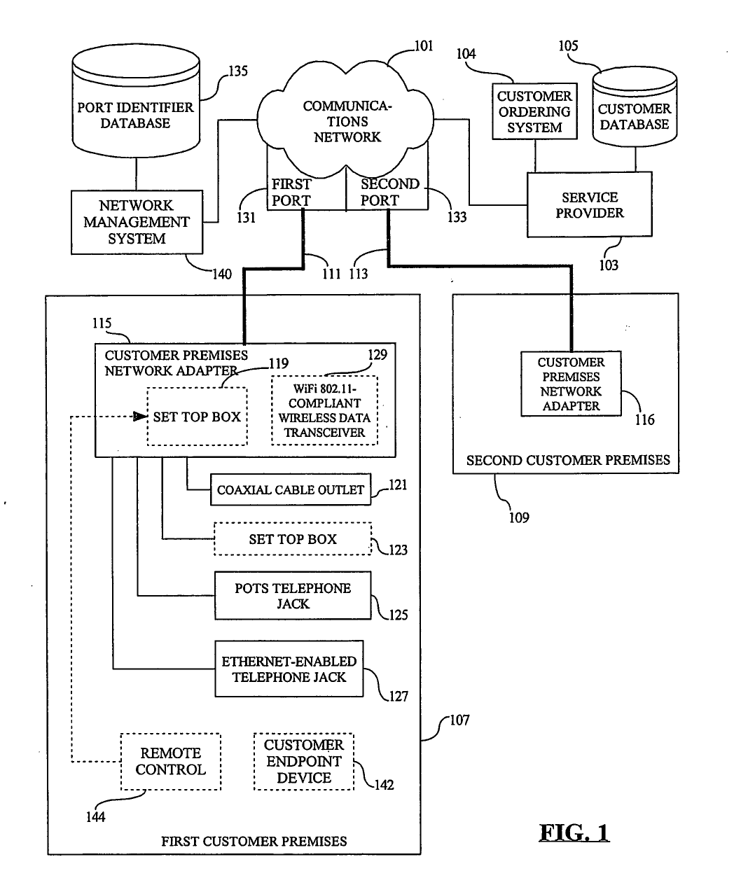

FIG. 1 is a block diagram of an exemplary system that may be utilized for ordering communication services from, e.g., a customer premises. First customer premises 107 and second customer premises 109 each represent a location such as a residence, home, apartment, condominium, office, dorm room, hotel room, or other place for which communication services may be ordered. These communication services are available from one or more communication service providers, such as service provider 103. Service provider 103 represents any provider of communication services, such as a cable company, a telephone carrier, a satellite communications company, an Internet service provider (ISP), a provider of Internet Protocol TV (IPTV), a company offering Voice over Internet Protocol (VoIP) services, a company offering digital subscriber loop (DSL) services, and others.

First customer premises 107 and second customer premises 109 are each equipped with a customer premises network adapter 115, 116, respectively. Customer premises network adapter 115 is associated with first customer premises 107, and not with any particular set of occupants at first customer premises 107. Alternatively or additionally, customer premises network adapter 115 may be assigned to a customer. Similarly, customer premises network adapter 116 is associated with second customer premises 109, and not with any particular set of occupants at second customer premises 109. Alternatively or additionally, customer premises network adapter 116 may be assigned to a customer. Pursuant to one illustrative set of embodiments, customer premises network adapter 115 remains installed at first customer premises 107, even if there is a change in the occupants at first customer premises 107, and even if the service provider 103 rendering service to first customer premises 107 is changed. Likewise, customer premises adapter 116 remains at second customer premises 109, even if the former occupants are replaced by new occupants, and service from a first service provider is discontinued in favor of service from a second service provider. Each of a plurality of respective customer premises 107, 109 is equipped with a corresponding customer premises network adapter 115, 116 which remains associated with the respective customer premises, illustratively for an indefinite or extended period of time.

Customer premises network adapters 115, 116 could, but need not, be installed and maintained by a given service provider, such as service provider 103. In this manner, customer premises network adapters 115, 116 would remain the property of service provider 103, such that subsequent occupants of a given space would be prohibited from removing, modifying, or destroying these adapters. Alternatively or additionally, customer premises network adapters 115, 116 may be installed and maintained by a condominium cooperative, a homeowners association, an apartment complex owner, an office complex, or the like. Moreover, customer premises network adapters 115, 116 could, but need not, be moved from a customer premises.

Illustratively, customer premises network adapters 115, 116 are each implemented using an Optical Network Termination (ONT). This implementation may be utilized, for example, in conjunction with Fiber to the Home (FTTH) technology whereby customers are provided with high-speed Internet access over a fiber optic communications link installed at the customer's residence. The design characteristics of a suitable ONT are discussed at greater length in International Telecommunications Union (ITU-T) Recommendations G.983.1 through G.983.11 and subsequent Amendments, all of which are incorporated by reference as if set forth fully herein.

Pursuant to another illustrative example, customer premises network adapters 115, 116 are each implemented using an Embedded Multimedia Terminal Adapter (EMTA). An EMTA is an adapter equipped to interface a POTS telephone with an Internet Protocol (IP)-based communications network such as those used by various cable companies. The EMTA may perform packetization and call signaling for any of a plurality of IP-based communication services, such as VoIP telephony, fax services, or data connectivity.

Regardless of the specific hardware elements used for customer premises network adapters 115, 116, these adapters are each capable of implementing communication between a communications network 101 and a customer endpoint device 142. More specifically, customer premises network adapters 115, 116 are each capable of establishing a communications link over a network, and are also capable of monitoring a respective customer premises 107, 109 in order to detect an initiation of communication by an endpoint device. Customer premises adapters 115, 116 are each also capable of interrogating a remote database over communications network 101. This remote database may include, for example, a customer database 105, to be described in greater detail hereinafter. Customer database 105 may be interrogated for the purpose of ascertaining whether or not a given customer premises, such as first customer premises 107, is served by a communication service, and/or interrogated for the purpose of ascertaining whether or not a communication service has been provisioned for first customer premises 107.

Communications network 101 represents, for example, the Internet, a private intranet, a public switched telephone network (PSTN), a cable television network, or any of various combinations thereof. Customer endpoint device 142 represents any device capable of generating a humanly discernible output from an electronic signal, or placing an input accepted from a user into electronic form, or both. Illustrative examples for endpoint device 142 include a television set, a landline telephone, a personal computer, a laptop computer, a personal digital assistant (PDA), a wireless telephone, an Ethernet-enabled device, a WiFi-enabled device, a media presentation device, or the like.

Customer endpoint device 142 is capable of being operatively coupled to customer premises network adapter 115 or 116 by means of one or more communication ports, such as a coaxial cable outlet 121, an optional set top box 123, a plain old telephone service (POTS) telephone jack 125, an Ethernet-enabled telephone jack 127, or an optional WiFi 802.11-compliant data transceiver 129. Use of an optional WiFi 802.11-compliant data transceiver 129 is described herein solely for illustrative purposes, and is not a requirement, as it should be clearly understood that data transceiver 129 is an optional component that could be implemented using a WiMax transceiver, or any other type of data transceiver capable of wireless communication. These one or more communication ports provide a mechanism by which initiation of communication at customer endpoint device 142 may detected at customer premises network adapter 115 or 116. In cases where endpoint device 142 is implemented using a television, an optional remote control 144 may be used to control the operation of the television. Optional remote control 144 is capable of communicating with optional set top box 123. Alternatively or additionally, the functionalities of a set top 119 box may be integrated into customer premises network adapter 115, whereupon optional remote control 144 is capable of communicating with optional set top box 119.

Customer premises network adapter 115 is operatively coupled to a first port 131 of communications network 101 via a first communications link 111. Similarly, customer premises network adapter 116 is operatively coupled to a second port 133 of communications network 101 via a second communications link 113. Communications network 101 is managed by a network management system 140. Network management system 140 maintains a port identifier database 135 setting forth port assignment information for each of a plurality of ports including first port 131 and second port 133. First port 131 and second port 133 may each be identified using a unique port identifier stored in port identifier database 135. Port assignment information associates each of a plurality of respective port identifiers with a corresponding customer premises identifier that uniquely identifies a specific customer premises, such as first customer premises 107 or second customer premises 109.

Communications network 101 is operably coupled to a service provider 103. Service provider 103 is any entity equipped to provide communications services over communications network 101 to a plurality of customer premises including first and second customer premises 107, 109. Illustratively, service provider 103 may represent a landline telephone carrier, a wireless communication company, a provider of high speed Internet connections, a cable television company, a VoIP provider, an internet protocol television (IPTV) provider, a supplier of video on demand programming, a supplier of interactive video games, a provider of audio entertainment, or the like. Network management system 140 and port identifier database 135 could, but need not, be associated with service provider 103.

Service provider 103 maintains a customer database 105 including premises identifying indicia for each of a plurality of customer premises. The premises identifying indicia may include, for example, the street addresses and zip codes for each of a plurality of customer premises, the latitude and longitude coordinates for each of a plurality of customer premises, or any other variable which can be used to uniquely specify a given customer premises from among a plurality of customer premises. Each of a plurality of respective premises identifying indicia is associated with a corresponding communication service provisioning specification. The communication service provisioning specification indicates whether or not a communication service has been provisioned for a respective premises. The communication service provisioning specification could, but need not, specify a periodic or usage-based charge for accessing a service such as broadband Internet access, VoIP, IPTV, or the like.

Communication service provisioning may be initiated through a customer ordering system 104 maintained by service provider 103. Customer ordering system 104 can be Internet-based, providing customers with access to a specified interactive website from which one or more communication services may be ordered. Alternatively or additionally, customer ordering system 104 can be telephonically based, such that customer orders for communication services are taken by live customer service representatives, by an automated interactive voice response system, or both. Alternatively or additionally, customer ordering system 104 may be adapted for use in conjunction with a media presentation device such as a television set, whereupon the media presentation device displays information about each of a plurality of communication services in the form of an interactive menu and a customer selects a communication service from the menu using an input mechanism such as a remote control in communication with set top box 123.

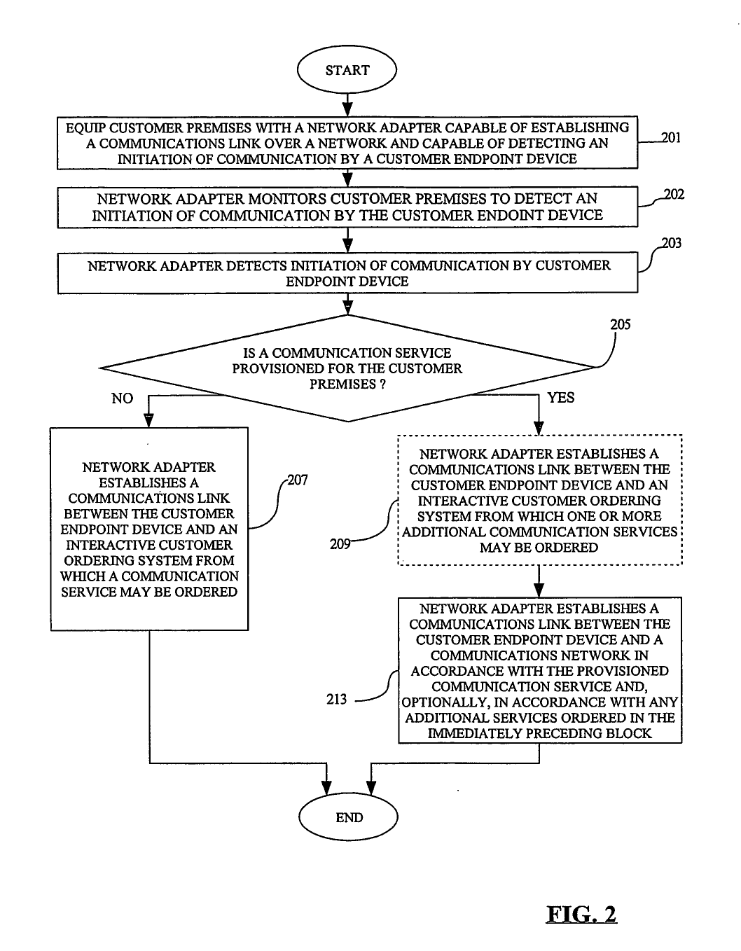

FIG. 2 is a flow diagram of a first exemplary process for ordering communication services from, e.g., a customer premises. At block 201, the customer premises is equipped with a network adapter (FIG. 1, 115) capable of establishing a communications link 111 over a network 101. By way of example, this communications link may be established between a customer endpoint device 142 and an ordering system 104 at a communications service provider 103, or between network adapter 115 and customer database 105 via service provider 103. The network adapter is also capable of detecting an initiation of communication by a customer endpoint device 142.

Illustratively, customer premises network adapter 115 is regarded as the property of service provider 103 or an entity contracting therewith, and is not the property of the occupant or occupants residing at first customer premises 107. Accordingly, customer premises network adapter 115 may remain at first customer premises 107 to provide communication services ordering capabilities to a set of new occupants after a set of existing occupants has moved to another location. Alternatively, network adapter 115 may remain with an occupant after the occupant moves from a first customer premises to a second customer premises.

At block 202 (FIG. 2), the customer premises network adapter monitors a customer premises, for example first customer premises 107 (FIG. 1), to detect an initiation of communication by a customer endpoint device, for example, customer endpoint device 142. Initiation of communication by the customer endpoint device is detected at block 203 (FIG. 2). The manner in which initiation of communication by the customer endpoint device is detected may, but need not, depend upon the type of endpoint device in use. For example, if the customer endpoint device is a personal computer, initiation of communication may be detected when a web browser on the computer is opened and the browser attempts to communicate over the Internet, when the customer endpoint device is plugged into network adapter 115, and/or when the customer endpoint device looks for an IP address. If the endpoint device is a telephone, initiation of communication may be defined as placement of the phone handset into an off-hook condition, because this act is generally indicative of a customer's intention to use the phone. If the endpoint device is a television set with a remote control, initiation of communication may be detected when a button on the remote is depressed to access media content available over communications network 101 (FIG. 1).

At block 205 (FIG. 2), a test is performed to determine whether or not a communication service is provisioned for the customer premises, illustratively by determining whether or not a dial tone is being provided to the customer premises, and/or by determining whether an IP address is assigned to the customer premises. Alternatively or additionally, a test is performed to determine whether or not the customer premises is served by a communication service. Block 205 could, but need not, be performed by the customer premises network adapter interrogating a remote database such as customer database 105 (FIG. 1) over communications network 101. For example, block 205 may be performed by interrogating customer database 105 to identify any communication service, or the category of communication service, which the service provider has agreed to provide to the customer premises. Optionally, block 205 checks not only to determine if service provider 103 has provisioned a communication service for the customer premises, but also optionally checks to determine if a provider other than service provider 103 has provisioned a communication service for the customer premises.

The negative branch from block 205 leads to block 207 where the customer premises network adapter establishes a communications link between the customer endpoint device and an interactive customer ordering system from which one or more communication services may be ordered. Illustratively, the interactive customer ordering system is Internet-based, telephonically based, operable in conjunction with a multimedia presentation device such as a television set, or any of various combinations thereof. In this manner, a new occupant moving into first customer premises 107 (FIG. 1) need merely initiate communication on a customer endpoint device 142 of their own choosing in order to procure a communication service from service provider 103 for their new residence. This functionality greatly simplifies the existing trial-and-error process by which many consumers select communication services after moving to a new customer premises. Moreover, service provider 103 is provided with a steady source of customers over time as successive sets of occupants move out of first customer premises to be replaced with new sets of occupants.

The affirmative branch from block 205 (FIG. 2) leads to optional block 209 where the network adapter establishes a communications link between the customer endpoint device and an interactive customer ordering system from which one or more additional communication services may be ordered. Since the customer premises is already being served by a communication service, this optional step represents an opportunity to market enhanced services to the customer above and beyond the service presently provisioned. For example, if existing service has been provisioned only for dial-up Internet access, the customer ordering system may permit the customer to upgrade this service to high-speed access, to order IPTV programming, or to order cable television service. Next (block 213), the network adapter establishes a communications link between the customer endpoint device and a network such as communications network 101 (FIG. 1) in accordance with existing communication service provisioning and, optionally, in accordance with any additional services ordered in the immediately preceding block.

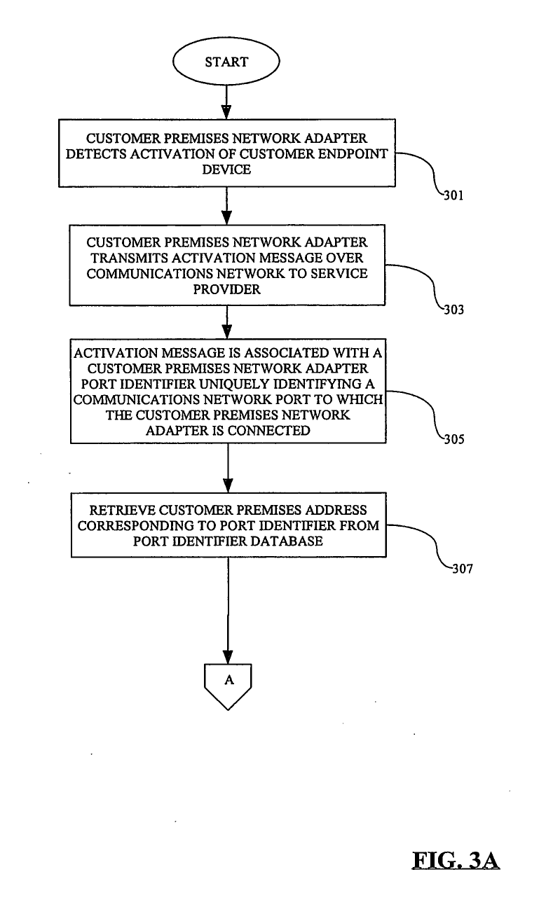

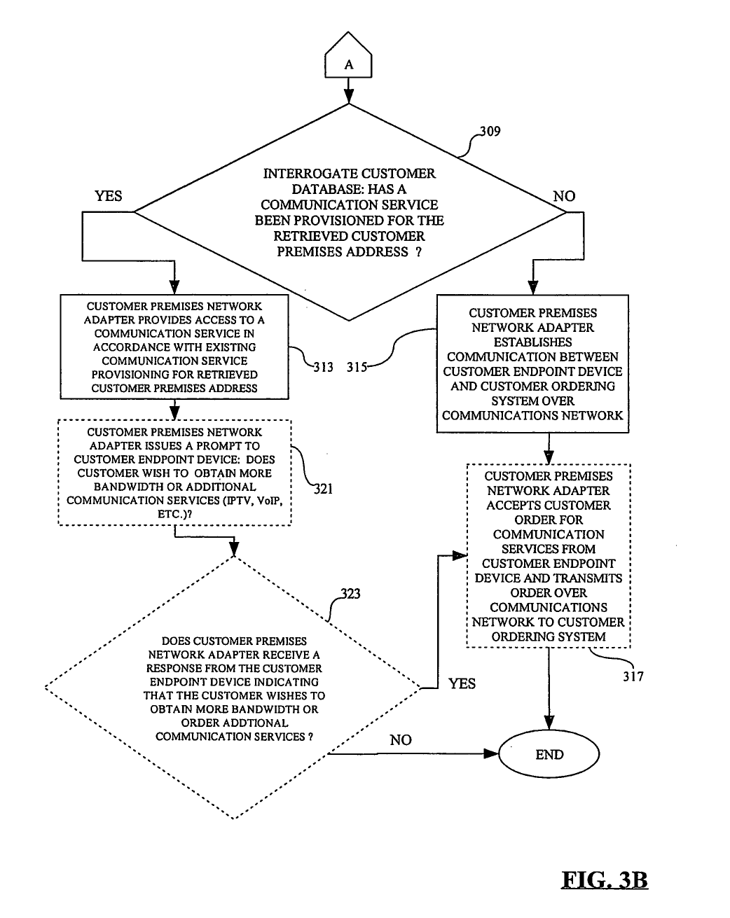

FIGS. 3A and 3B together comprise a flow diagram of an exemplary process for ordering communication services from a customer premises. The program commences at block 301 (FIG. 3A) where customer premises network adapter 115 (FIG. 1) detects activation of a customer endpoint device 142. For example, assume that customer endpoint device 142 is implemented in the form of a personal computer owned by a new occupant who is the process of moving into first customer premises 107. The occupant installs a cable between an Ethernet card in the personal computer and Ethernet-enabled telephone jack 127. The occupant boots up the personal computer, activates a web browsing program, and attempts to access the Internet. Customer premises network adapter 115 detects the personal computer's attempt to access the Internet via Ethernet-enabled telephone jack 127.

Pursuant to another illustrative example of executing block 301 (FIG. 3A), customer endpoint device 142 (FIG. 1) is implemented using a POTS telephone. The occupant connects a cable between POTS telephone jack 125 and the POTS telephone. The occupant takes the POTS telephone off hook and attempts to place an outgoing call. Customer premises network adapter 115 detects activation of the POTS telephone attempting to access communications network 101 when the telephone is taken off hook. As used herein, the term POTS telephone may encompass a plain, ordinary telephone set as well as other telephonic devices such as cordless telephones, telephone answering machines, touch tone telephones, and the like.

Pursuant to yet another illustrative example of executing block 301 (FIG. 3A), customer endpoint device 142 (FIG. 1) is implemented using a television set. The occupant connects the television set to coaxial cable outlet 121, powers up the television set, and activates remote control 144 in an attempt to access a program distributed over communications network 101. The activation of remote control 144 is detected by optional set top box 119 of customer premises adapter 115, or is detected by optional set top box 123 which communicates such detection to customer premises adapter 115.

Referring now to block 303 (FIG. 3A), the customer premises network adapter transmits an activation message over communications network 100 (FIG. 1) to service provider 103. This activation message provides an indication that a customer endpoint device has been activated at a customer premises. Next, the activation message is associated with a customer premises network adapter port identifier that uniquely identifies a communications port on the communications network to which the customer premises network adapter is connected (FIG. 3A, block 305). Illustratively, this step may be performed by customer premises network adapter 115 (FIG. 1) interrogating network management system 140, or by communications network 101 automatically associating a network port identifier with the activation message.

At block 307 (FIG. 3A), a customer premises address corresponding to the network port identifier is retrieved from port identifier database 135 (FIG. 1). Using the retrieved customer premises address, a database such as customer database 105 is interrogated to determine whether or not a communication service has been provisioned for the retrieved customer premises address (FIG. 3A, block 309). If not, the program advances to block 315 where the customer premises network adapter establishes communication between the endpoint device and customer ordering system 104 (FIG. 1) over the communications network. Optionally, the customer premises network adapter accepts a customer order for communication services from the endpoint device and transmits this order over the communications network to the customer ordering system (FIG. 3B, block 317).

The affirmative branch from block 309 leads to block 313 where the customer premises network adapter provides access to a communication service in accordance with existing communication service provisioning for the retrieved customer premises address. Optionally, at block 321 the customer premises network adapter issues a prompt to the endpoint device asking the customer if he or she wishes to obtain more bandwidth or order additional communication services such as IPTV, VoIP, or the like. At block 323, a test is performed to ascertain whether or not the customer premises network adapter receives a response from the endpoint device indicating that the customer wishes to obtain more bandwidth or order additional communication services. If not, the program ends. The affirmative branch from block 323 leads to block 317, discussed previously.

As described heretofore, the exemplary embodiments can be provided in the form of computer-implemented processes and apparatuses for practicing those processes. The exemplary embodiments can also be provided in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be provided in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of ordering a communication service, the method comprising:
monitoring a customer premises to detect an initiation of communication by an endpoint device at the customer premises and, upon detection thereof,
determining whether or not a communication service is provisioned for the customer premises and, if a communication service is not provisioned for the customer premises, then
initiating a communications link between the endpoint device and an ordering system of a service provider.

2. The method of claim 1 wherein, if a communication service is provisioned for the customer premises, the communications link is not initiated.

3. The method of claim 1 wherein the communication service includes at least one of broadband Internet access, Voice over Internet Protocol (VoIP), Internet Protocol television (IPTV), cable television, interactive gaming, wireless voice communication, wireless data communication, or telephonic communication.

4. The method of claim 1 wherein, if a communication service is provisioned for the customer premises, the method further includes issuing a prompt to the endpoint device offering a choice of one or more additional communication services which may be ordered from the service provider

5. The method of claim 1 wherein determining whether or not a communication service is provisioned for the customer premises is performed by initiating a communications link to the service provider over the network, wherein information is obtained from an electronic customer database maintained by the service provider.

6. The method of claim 1 wherein the initiation of a communications link comprises at least one of placing a telephone handset into an off-hook condition, activating a web browser program on a computing device, and depressing a button on a remote control.

7. A computer program product comprising a storage medium readable by a processing circuit and storing instructions for execution by the processing circuit for facilitating a method of ordering a communication service, the method comprising:
monitoring a customer premises to detect an initiation of communication by an endpoint device at the customer premises and, upon detection thereof,
determining whether or not a communication service is provisioned for the customer premises and, if a communication service is not provisioned for the customer premises, then
initiating a communications link between the endpoint device and an ordering system of a service provider.

8. The computer program product of claim 7 wherein, if a communication service is provisioned for the customer premises, the communications link is not initiated.

9. The computer program product of claim 7 wherein the communication service includes at least one of broadband Internet access, Voice over Internet Protocol (VoIP), Internet Protocol television (IPTV), cable television, interactive gaming, wireless voice communication, wireless data communication, or telephonic communication.

10. The computer program product of claim 7 wherein, if a communication service is provisioned for the customer premises, the program further includes instructions for issuing a prompt to the endpoint device offering a choice of one or more additional communication services which may be ordered from the service provider.

11. The computer program product of claim 7 wherein determining whether or not a communication service is provisioned for the customer premises is performed by initiating a communications link to the service provider over the network, wherein information is obtained from an electronic customer database maintained by the service provider.

12. The computer program product of claim 7 wherein the initiation of a communications link comprises at least one of placing a telephone handset into an off-hook condition, activating a web browser program on a computing device, and depressing a button on a remote control.

13. An apparatus for enabling a communication service to be ordered, the apparatus comprising:
a communications link initiation mechanism for initiating a communications link between an endpoint device and an ordering system of a service provider;
a monitoring mechanism for monitoring a customer premises to detect an initiation of communication by an endpoint device at the customer premises; and
an interrogation mechanism for interrogating a customer database to determine whether or not a communication service is provisioned for the customer premises;
wherein the communications link initiation mechanism initiates a communications link between the endpoint device and the ordering system in response to the initiation of communication by the endpoint device if a communication service is not provisioned for the customer premises.

14. The apparatus of claim 13 wherein, if a communication service is provisioned for the customer premises, the communications link between the endpoint device and the ordering system is not initiated.

15. The apparatus of claim 13 wherein the communication service includes at least one of broadband Internet access, Voice over Internet Protocol (VoIP), Internet Protocol television (IPTV), cable television, interactive gaming, wireless voice communication, wireless data communication, or telephonic communication.

16. The apparatus of claim 14 further comprising a prompt issuing mechanism wherein, if a communication service is provisioned for the customer premises, the apparatus issues a prompt to the endpoint device offering a choice of one or more additional communication services which may be ordered from the service provider.

17. The apparatus of claim 14 wherein the interrogation mechanism determines whether or not a communication service is provisioned for the customer premises by obtaining information from an electronic customer database maintained by the service provider, and wherein the initiation of communication comprises at least one of placing a telephone handset into an off-hook condition, activating a web browser program on a computing device, or depressing a button on a remote control.
